(19) United States
(12) Patent Application Publication
(10) Pub. No.: US 2004/0099110 A1
(43) Pub. Date: May 27, 2004

(54) Apparatus for removing plastic wrapping film from pallets of products

(76) Inventor: Mauro Cere, Loiano (IT)

Correspondence Address: Richard J Minnich, Fay Sharpe Fagan Minnich & McKee, 1100 Superior Avenue 7th Floor, Cleveland, OH, 44114, US

(21) Appl. No.: 10/333,193

(22) PCT Filed: Jul. 25, 2001
(86) PCT No.: PCT/IB01/01334

(30) Foreign Application Priority Data
Jul. 31, 2000 (IT) B 02000/000474

(51) Int. Cl. B26D 7/06

(52) U.S. Cl. 83/78; 83/559

(57) ABSTRACT

An apparatus for removing plastic wrapping film, in particular stretch film, from pallets (1) of products comprises: a pair of cutting devices (2) positioned on opposite sides of the pallet (1), acting on the opposite vertical surfaces (1a, 1b) of the pallet (1) and mobile along a horizontal axis (X), allowing the film (3) to be cut along the vertical surface (1a, 1b) and close to the upper surface (1c) of the pallet (1); an operating unit (4) at each vertical surface (1a, 1b) cut and comprising belts (5) which pick up the lower flap (6) of the film (3) cut; blades (7) for cutting the film (3) along vertical axes (Z, Z′), to the base of the pallet (1), creating two separate flaps (8, 9, 8, 9′) for each vertical surface (1a, 1b) and drive means (10) for rotating the pick up belts (5), to allow the opening of each pair of flaps (8, 9, 8, 9) away from the respective vertical surface (1a, 1b); a mobile unit (11) for picking up the pairs of flags (8, 9, 8 9) and completely removing teh wrapping film (3) from the pallet (1), when the pick up belts (5) release teh flaps (8, 9, 8 9).

### TECHNICAL FIELD

The present invention relates to an apparatus for removing plastic wrapping film from pallets of products, in particular stretch plastic film.

### BACKGROUND ART

At present, in the sector for wrapping products on pallets, use of stretch film is increasing because it is more practical and economical than heat-shrink film, which requires a step of heating in an oven after wrapping. Obviously, large pallets require large ovens and large amounts of power which are expensive.

The choice of stretch film for wrapping pallets of products (such as bottles, containers made of various materials, etc.) has lead to a diversification in the manufacture of apparatuses for removing the film from the pallet when the pallet arrives at its destination and the products contained in it must be used.

In a known solution, described in patent EP-692.430, use is made of an apparatus whose main parts comprise a pallet support base, a gripper with a knife which slides vertically for central pick up and cutting of one side of the film, an upper plate close to the upper base of the pallet, there being film suction and cutting means on the base, and a pair of arms with grippers, located on either side of the upper plate, which pick up the two flaps cut by the previous gripper.

Basically, said apparatus allows removal of the layer of film from the pallet by means of: a central and vertical cut, from the bottom upwards, in the film along one side of the parallelepiped forming the pallet, by the gripper with the knife; a shaped cut in the film at the top of the parallelepiped, by the cutting means on the upper plate; pick up of the two flaps created as a result of cutting, by the grippers supported by the two arms, with subsequent rotation, book-style, of the flaps cut about the respective vertical axis, substantially coinciding with the edges of the parallelepiped opposite the surface cut.

After flap opening, a pick up and compacting unit for the film removed is activated, allowing the film to be compacted and carried away from the apparatus.

However, when the products being handled are foodstuffs, the pallet also has a so-called “aseptic” separator sheet on the bottom of it, under the first layer of products. The aseptic sheet projects from the pallet perimeter. In this way, as the stretch film is wrapped, the aseptic sheet makes contact with, or stably adheres to the stretch film, forming a safety barrier designed to prevent the passage of dust or other contaminants towards the products (in particular from below) when the pallets are left standing in warehouses or storage yards.

Pallets with this aseptic sheet make the removal of stretch film by the above-mentioned apparatus more difficult, since the fact that the aseptic sheet adheres to the film on the lower part creates significant resistance during book-style film opening, with two effects: dangerous slipping of the products during film removal operations, due to the tensions created on the upper part by the opening thrust from the arms and the resistance at the points at the base of the pallet where the aseptic sheet adheres to the film and possible tears in the film with the consequent need for manual removal of the parts left in contact with the pallet.

### DISCLOSURE OF THE INVENTION

The aim of the present invention is, therefore, to overcome the above-mentioned disadvantage by providing an apparatus for removing plastic film used to wrap pallets of products, in particular stretch plastic film, structured in such a way that it allows rapid and safe film removal from the pallet even if an aseptic sheet is present at the bottom of the pallet.

Accordingly, the present invention, as described in the claims herein, solves the problem of providing an apparatus for removing plastic film used to wrap pallets of products, in particular stretch plastic film. The apparatus comprises a pair of cutter elements, on opposite sides of the pallet, operating on the opposite vertical surfaces of the pallet and mobile along a horizontal axis, allowing the film to be cut along the vertical surface and close to the upper surface of the pallet; an operating unit is located at each of the vertical surfaces cut and comprises belts which pick up the lower flap of the film cut, blades for cutting the film along vertical axes to the base of the pallet, creating two separate flaps for each vertical surface and drive means for rotating the pick up belts, to allow the opening of each pair of flaps away from the respective vertical surface; the apparatus also having a mobile unit for picking up the pair of flaps and completely removing the wrapping film from the pallet.

The technical features of the present invention, in accordance with the above aims, are apparent in the claims herein, and the advantages are more clearly described in the detailed description below, with reference to the accompanying drawings, which illustrate a preferred embodiment of the invention, without limiting the scope of its application, and in which:

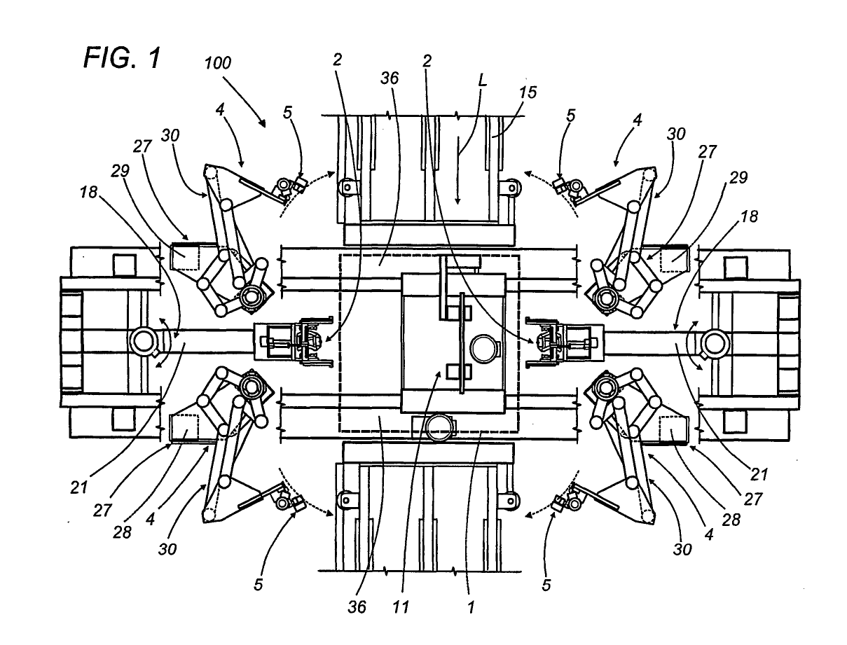

FIG. 1 is a schematic top plan view with some parts cut away to better illustrate others, of an apparatus for removing plastic film used to wrap pallets, made in accordance with the present invention;

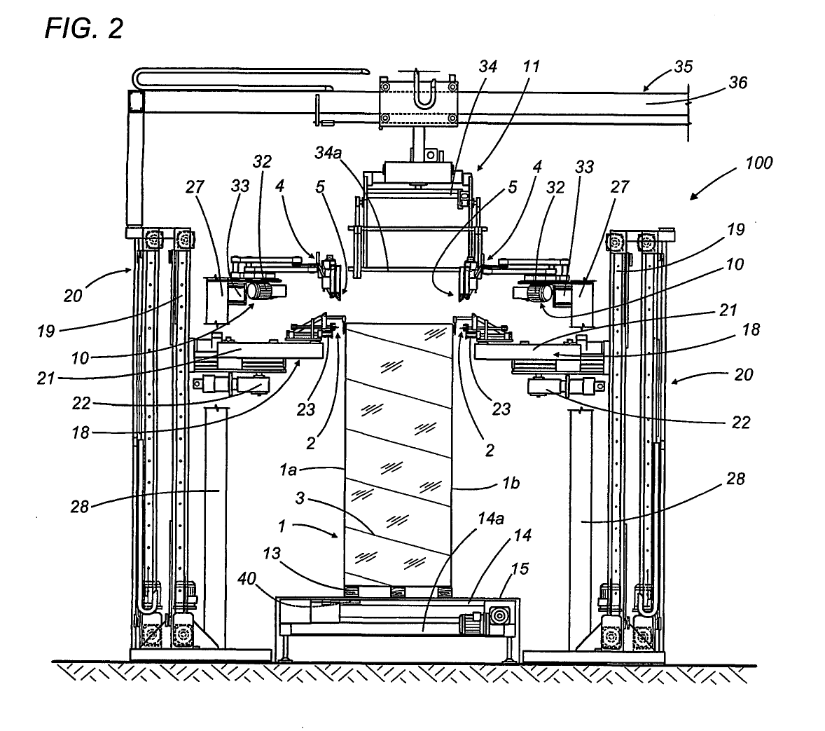

FIG. 2 is a schematic side view with some parts cut away to better illustrate others, of the apparatus illustrated in FIG. 1;

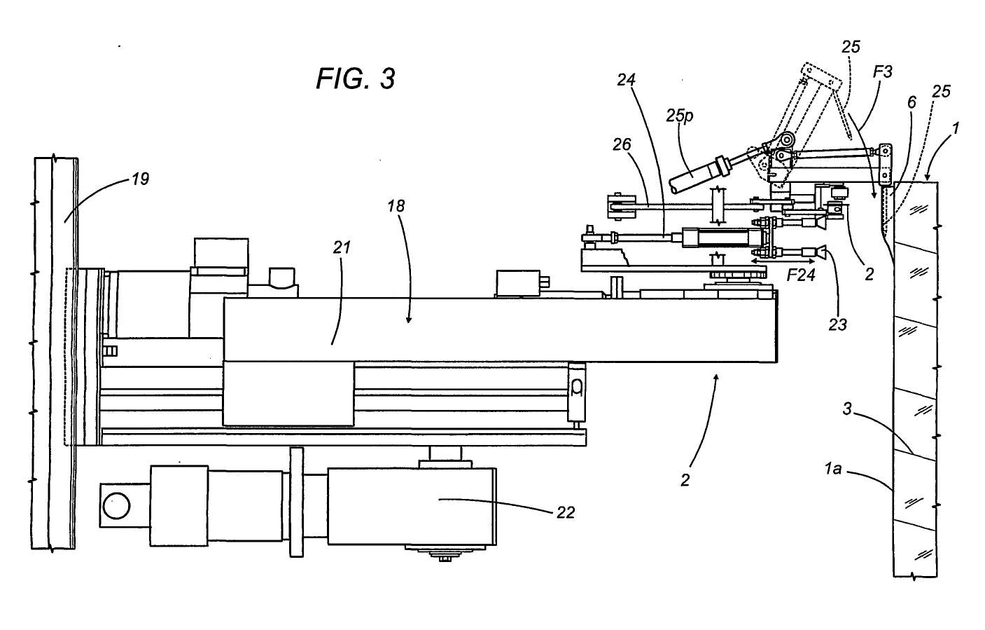

FIG. 3 is a schematic side view with some parts cut away to better illustrate others, of a first transporting assembly forming part of the apparatus illustrated in FIGS. 1 and 2;

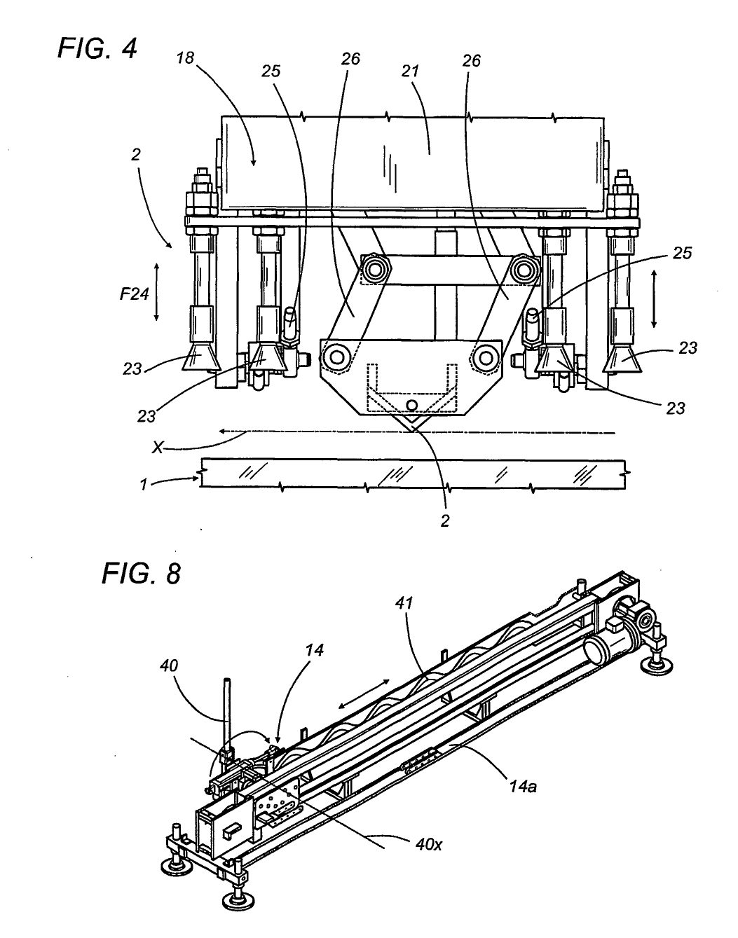

FIG. 4 is a bottom plan view with some parts cut away to better illustrate others, of part of the first transporting assembly illustrated in FIG. 3;

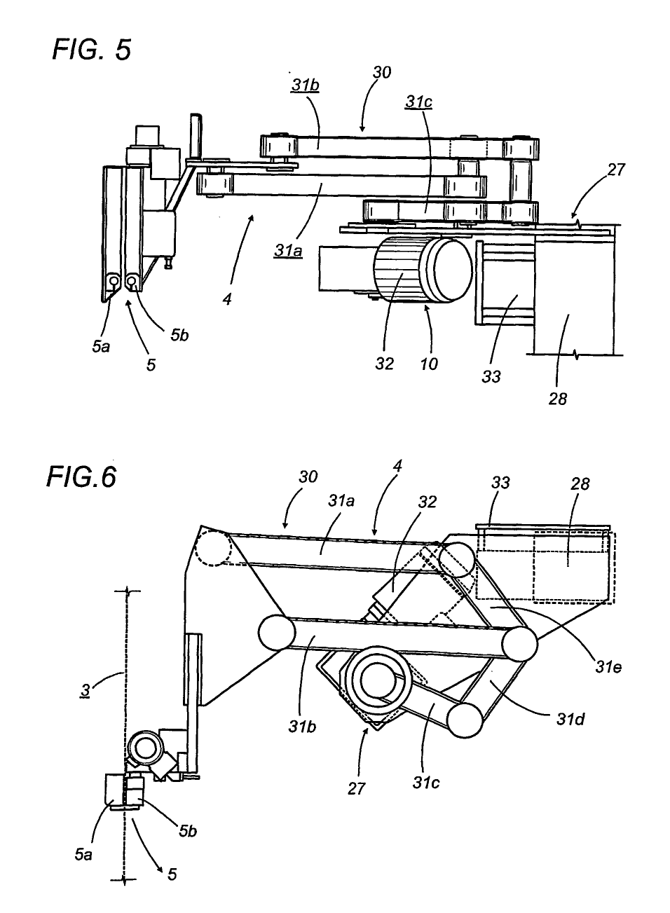

FIGS. 5 and 6 are respectively a side view and a top plan view of a second transporting assembly forming part of the apparatus illustrated in FIGS. 1 and 2;

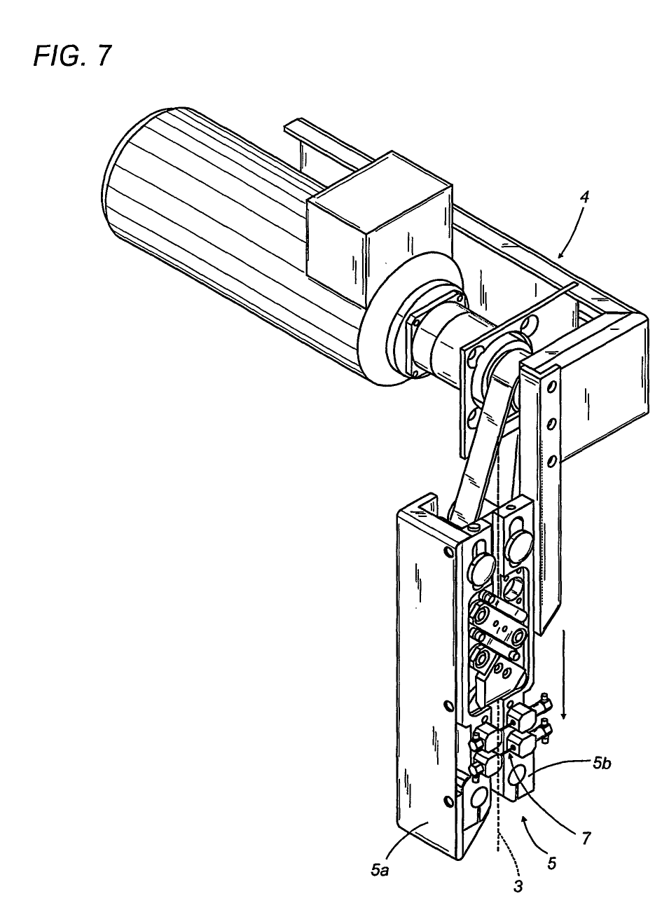

FIG. 7 is a perspective view with some parts cut away to better illustrate others, of a detail of the second transporting assembly illustrated in FIGS. 5 and 6, that it to say, the gripper belts;

FIG. 8 is a perspective view with some parts cut away to better illustrate others, of a unit used to tear the bottom of the film and forming part of the apparatus illustrated in FIGS. 1 and 2;

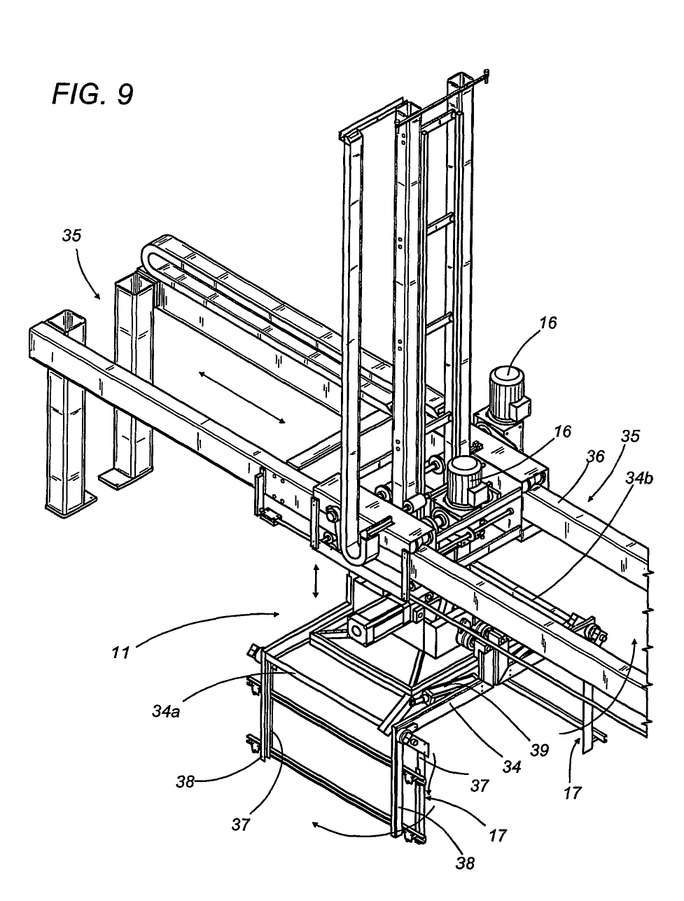

FIG. 9 is a perspective view with some parts cut away to better illustrate others, of a mobile unit for completely removing the wrapping film and forming part of the apparatus illustrated in FIGS. 1 and 2;

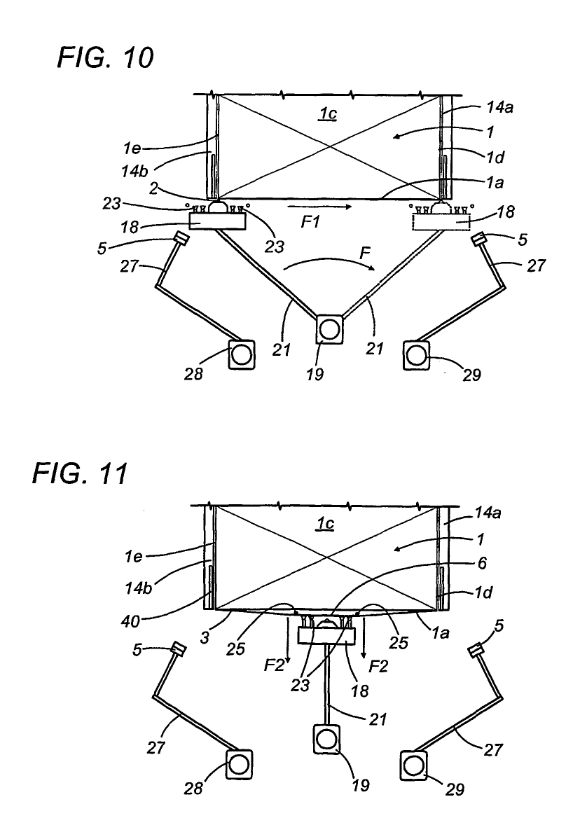

FIGS. 10, 11 and 12 are schematic top plan views of steps of removing the film which are possible using the apparatus illustrated in the previous figures;

FIG. 13 is a schematic side view of another step of removing the film;

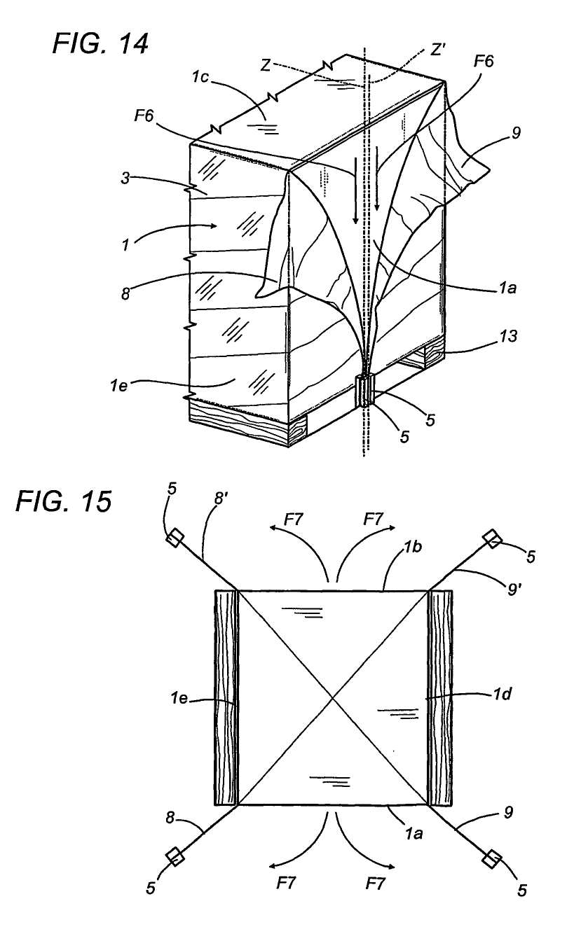

FIG. 14 is a schematic perspective view of another step of removing the film;

FIG. 15 is a schematic top plan view of another step of removing the film;

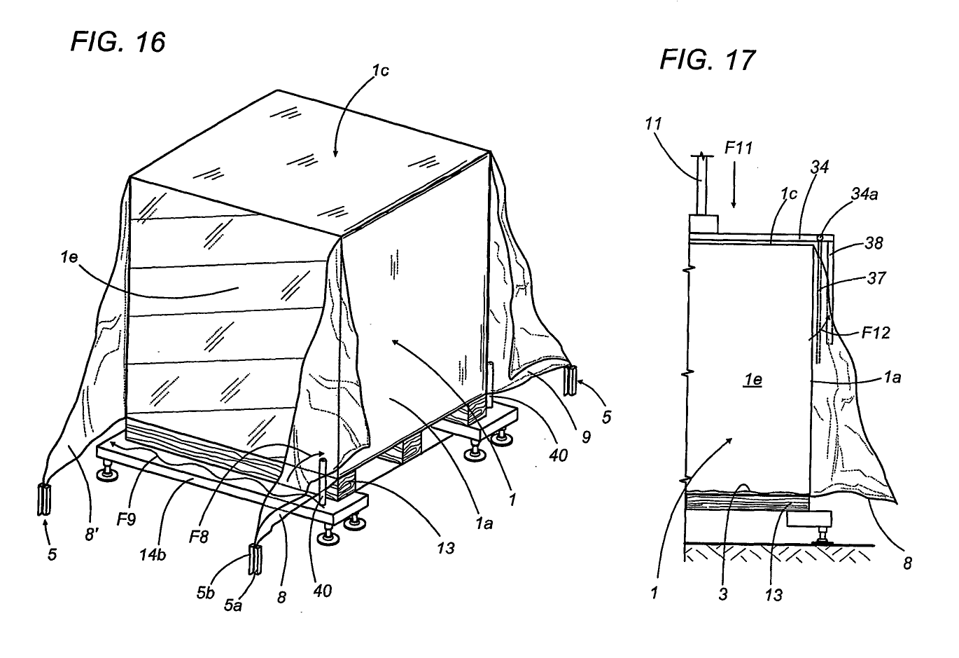

FIG. 16 is a schematic perspective view of another step of removing the film;

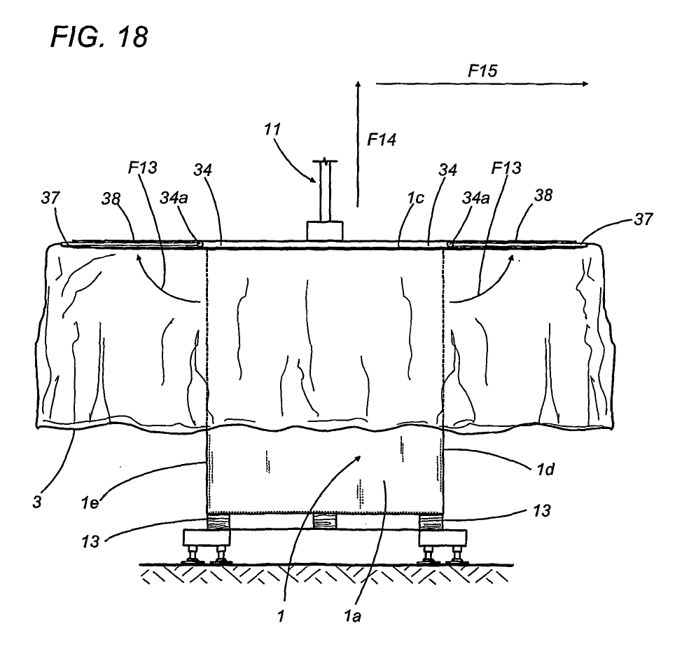

FIGS. 17 and 18 are schematic side views of corresponding steps of removing the film.

With reference to the accompanying drawings, and in particular with reference to FIGS. 1 and 2, the apparatus disclosed is used to remove plastic wrapping film, in particular stretch film, from pallets 1 of products.

The apparatus may be included in automated lines comprising a pallet 1 handling surface 15, where the wrapping film 3 must be removed, according to a line L of feed to the apparatus, which is labelled 100 as a whole.

The basic elements of which the apparatus is composed are: a pair of cutting devices 2, an operating unit 4 which picks up, cuts and moves the flaps of film 3 cut, lower film 3 separation means 14 and a mobile unit 11 for picking up and completely removing the film 3 from the pallet 1.

Looking more closely at the technical details, also with reference to FIGS. 3 and 4, the two cutting devices 2 are positioned on opposite sides of the pallet 1 and operate on the opposite vertical surfaces 1a and 1b of the pallet 1.

Each of the cutting devices 2 is mobile at least along a corresponding horizontal axis X, allowing the film 3 to be cut along the corresponding vertical surface 1a or 1b, close to the upper surface 1c of the pallet 1.

Structurally, each of the cutting devices 2 comprises a first transporting assembly 18 which is mobile vertically (as well as horizontally), in both directions, along a first vertical column 19 which is part of a frame 20 that supports the apparatus 100.

Each of the first transporting assemblies 18 consists of a beam 21, one end of which forms a carriage for vertical movement of the first transporting assembly 18, whilst the other end supports the cutting device consisting of a blade 2.

In addition, each first transporting assembly comprises drive means 22 (customary gear motors) for rotating the beam 21 about the first column 19 to angle the blade 2 along a straight, horizontal film 3 cutting plane close to the upper surface 1c of the pallet 1.

The blade 2 also has a pair of support levers 26, joined to one another and connecting it to the support beam 21. The specific function of the levers is to allow an adjustment movement, towards or away from the vertical surface 1a and 1b of the pallet 1, allowing the blade 2 a stable cutting contact in a horizontal direction, on the film 3, along the entire cutting path (all preferably controlled by a gear motor).

Each beam 21 is also fitted with a plurality of vacuum pick up means 23 (for example, suction cups) for the lower flap 6 cut, located on opposite sides of the blade 2 and mobile, thanks to relative means 24 (for example, fluid-driven pistons), between a first, non-operating back position, distanced from the surface 1a or 1b, a second, forward position in which they adhere to the flap 6 close to the horizontal cut previously made by the blade 2, and, finally, a third, operating position, in which they are back, distancing the lower flap 6 cut from the vertical surface 1a, 1b and forming a loop in the film 3 cut (see arrows F24).

In order to keep the loop created by the suction cups 23 taut, each first transporting element 18 comprises a pair of retaining pins 25 which hold the flap 6 of film 3 distanced.

The pins 25 are located close to the pick up suction cups 23 and are mobile, by means of a piston 25p, between a non-operating raised position (illustrated with a dashed line in FIG. 3), in which the pins 25 are distanced from the flap 6, and a lowered holding position, in which the pins 25 are inserted between the vertical surface 1a and 1b of the pallet 1 and the film 3 cut. This allows safer, easier insertion of the operating unit 4.

The above-mentioned operating unit 4 (see also FIGS. 5, 6 and 7) is located at each vertical surface 1a and 1b cut and comprises: means 5 for picking up the lower flap 6 of the film 3 cut; means 7 for cutting the film 3 along the vertical axes Z, Z′, to the base 13 of the pallet 1, forming two separate flaps 8, 9, 8′, 9′ for each vertical surface 1a and 1b, and drive means 10, which cause the pick up means 5 to rotate, allowing the opening of each pair of flaps 8, 9, 8′, 9′ away from the vertical surface 1a and 1b.

More specifically, each operating unit 4 comprises a pair of second transporting assemblies 27 for each vertical surface 1a and 1b to be cut, these assemblies being independent of one another, and each connected to a second vertical column 28 and 29 forming part of the apparatus 100 frame 20.

Each second transporting assembly 27 is fitted with the above-mentioned drive means 10, designed to allow synchronised movement of the four transporting assemblies 27 along the second vertical columns 28 and 29, for film 3 pick up and cutting and for rotation of the pair of flaps 8, 9, 8′, 9′ formed at the lower end, that is to say, the base 13 of the pallet 1.

More precisely, each second transporting assembly 27 comprises means 30 for supporting and rotating about the second vertical column 28 and 29 a pair of belts 5a and 5b set opposite one another, forming the pick up means 5, for the pick up and tensioning of the lower flap 6 of the film 3 cut and designed to form a vertical passage for the film 3 when the transporting assemblies 27 are lowered.

The film 3 held taut between the belts 5a and 5b can be intercepted by at least one film 3 cutter blade 7, supported by the belts Sa and 5b, the blade 7 being positioned across the vertical passage formed by the belts 5a and 5b (see FIG. 7). As is clearly illustrated in FIGS. 5 and 6, the means 30 for supporting and rotating each second transporting assembly 27 comprises a plurality of support arms 31a, 31b, 31c, 31d, 31e, linked to one another and forming a five-sided arm, and controlled by a drive unit 32 attached to a support carriage 33 (forming the drive means 10) for the second transporting assembly 27 and slidably linked to the second column 28 and 29.

The arms 31a, 31b, 31c, 31d, 31e are linked to one another in such a way that the second transporting assembly 27 can rotate between at least two end positions in a horizontal plane. One of the positions is a non-operating position, in which each second transporting assembly 27 is distanced from the vertical surface 1a or 1b of the pallet 1 (see FIG. 1), and another is an operating position, in which each second transporting assembly 27 is close to the vertical surface 1a or 1b (see FIG. 6) and the pair of belts 5a and 5b intercepts the lower flap 6 of film 3 cut.

To obtain secure insertion between the belt and the vertical surface 1a or 1b of the pallet 1, at least one of the belts, the outer one labelled 5a, of each pair of belts 5a and 5b of each second transporting assembly 27 has a tapered end.

FIGS. 1, 2 and 9 illustrate the above-mentioned mobile unit 11 for picking up the pairs of flaps 8, 9, 8′, 9′ and completely removing the wrapping film 3 from the pallet 1, after the flaps 8, 9, 8′, 9′ of film 3 cut are released by the belts 5a and 5b.

The mobile pick up unit 11 comprises vertical drive means 16, for moving the unit 11 above the pallet 1, allowing the flaps 8, 9, 8′, 9′ of film 3 to be picked up when necessary, and means 17 for opening the flaps 8, 9, 8′, 9′ away from the pallet 1, so as to pick up and remove all of the wrapping film 3.

Looking more closely at the technical details, the unit 11 comprises a frame 34 which is mobile along a bridge structure 35 above the zone for removal of the film 3 from the pallet 1.

The mobile frame 34 is fitted with the above-mentioned means 16 (customary drive motors) designed to allow a frame 34 adjustment movement, in both directions, along a horizontal beam 36 which is part of the bridge structure 35 (again part of the apparatus 100 frame 20) and its height adjustment, allowing the frame 34 to be moved towards and away from the pallet 1.

The mobile frame 34 comprises a fixed horizontal portion, equipped on either side with rotary vertical frames 34a and 34b, each comprising a first pair of mobile arms 37 which can be positioned opposite a matching second pair of fixed arms 38, forming separate pairs of grippers for the rotated flaps 8, 9, 8′, 9′ of film 3.

The vertical frames 34a and 34b have drive means 39 (for example, pistons) designed so that, when the frame 34 is in the lowered position above the pallet 1, the flaps 8, 9, 8′, 8′ are picked up and, as the vertical frames 34a and 34b are simultaneously rotated, the flaps 8, 9, 8′, 9′ are lifted away from the pallet 1, allowing the film 3 to be completely from the pallet 1.

The above-mentioned separation means 14 (see also FIG. 8) are used, in particular but without limiting the scope of application, if the pallet 1 has an additional lower sealing sheet 12 (also called “aseptic”) on the base 13 of the pallet 1. This additional sheet 12 (visible in the enlarged detail in FIG. 13), projects from the outer perimeter of the base 13 and makes stable contact with the portion of film 3 wrapped around the lower base 13.

These means 14 for separating the additional sheet 12 of film from the film 3 on the base 13 operate at the additional vertical surfaces Id and 1e of the film 3, which are still intact, on the pallet 1 at the base 13 of the pallet 1.

FIG. 2 illustrates how the separation means 14 are located below the pallet 1 support and movement surface 15, and comprise two separate units 14a and 14b, on opposite sides of the pallet 1, ready-positioned for film 3 removal operations.

More precisely, each unit 14a and 14b operates transversally relative to the pallet 1 movement line L on the surface 15.

FIG. 8 illustrates how each tear-off unit 14a and 14b comprises a tear-off pin 40, which rotates about a horizontal axis 40x, between a non-operating position, in which the pin 40 is lowered in a horizontal configuration, and an operating tear-off position, in which the pin 40 is raised, in a vertical configuration and at the base 13 of the pallet 1, so that it is inserted between the film 3 and the lower, additional sealing sheet 12 on the intact vertical surfaces 1d and 1e of the pallet 1.

Each unit 14a and 14b is equipped with an undulating guide 41, on which the pin 40 slides, moved by a kinematic chain which is not illustrated, and designed so that when the pin 40 is moving parallel with the length of the base 13 and is in the tear-off position, it can perform an undulating tear-off movement on the lower zone of the film 3 and the sealing sheet 12, on the surfaces 1d and 1e of the pallet 1. This undulating movement allows improved tear-off capacity, even if not complete, without excessively tensioning the film 3 or the sheet 12, which could make the products on the pallet 1 unstable.

The apparatus structured in this way functions as follows, starting with a start cycle configuration with positioning of a pallet 1 from which the wrapping film 3 must be removed.

The pallet 1 is locked in position, then the two first transporting assemblies 18, close to the surfaces 1a and 1b of the pallet 1 are activated, and are positioned at one end of the surfaces 1a and 1b (see FIG. 10). At this point, each blade 2 makes contact with the film 3 (using special sensors) close to the upper surface 1c. Next, film 3 cutting begins, by rotating the beam 21 (see arrow F in FIG. 10), while the levers 26 hold the blade 2 in a horizontal direction (see arrow F1) relative to the length of the surface 1a or 1b.

Upon completion of the cut in the film 3, the beam 21 moves to a central position relative to the surface 1a or 1b by means of vertical adjustment of the beam along the first column 19 (see FIG. 11). After positioning, the suctions cups 23 are activated, to pick up the lower flap 6 of film 3 cut, which is then drawn away from the surface 1a and 1b (see arrow F2 in FIG. 11). The loop obtained by the suction cups 23 is held and stabilised by lowering the pins 25 (see arrow F3 in FIG. 3) and inserting them between the film 3 and the surfaces 1a and 1b.

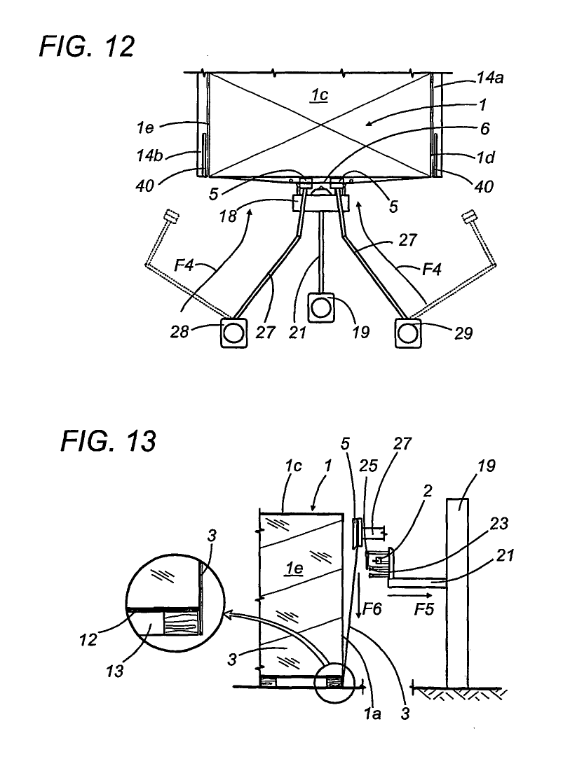

The second transporting assemblies 27 are then activated (two on each side). Thanks to the special configuration of the five-sided arms 31a, 31b, 31c, 31d, 31e, the transporting assemblies position the belts Sa and 5b (see arrow F4 in FIG. 12) at the film 3 loop created by the first transporting assembly 18 (again see FIG. 12) and above the first transporting assembly 18.

The pairs of belts 5a and 5b are lowered towards the flap 6 (thanks to movement of the carriage 33) and grip a portion of film 3 in the passage formed by the belts 5a and 5b. At this point, the first transporting assemblies 18 can be disabled and moved away from the operating zone (see arrow F5 in FIG. 13), whilst the second transporting assemblies 27 begin their downstroke, at synchronised speeds, towards the base 13 of the pallet 1 (see arrow F6 in FIGS. 13 and 14).

The belts 5a and 5b of each second transporting assembly 27 reach the base 13 of the pallet 1, dividing, if present, even the additional aseptic sheet 12, and are paused here by the carriage 33 stopping.

At this point, the arms 31a, 31b, 31c, 31d, 31e are activated again (see arrow F7 in FIG. 15), allowing the opening of the four flaps 8, 9, 8′, 9′ created by the cut by the belts 5a and 5b, to form a sort of “X”, as illustrated in FIG. 15 and they remain temporarily locked here.

When the flaps 8, 9 and 8′ and 9′ have been opened, the tear-off units 14a and 14b are activated, that is to say, the two tear-off pins 40 are raised (see arrow F8 in FIG. 16) and, by means of the above-mentioned undulating motion (see arrow F9 in FIG. 16), separate the film 3 from the aseptic sheet 12 on the sides which are still intact 1d and 1e, also opening the lower portion of these sides. Upon completion of this operation, the pins 40 rotate again into the lowered, non-operating position.

At this point, the mobile unit 11 is activated. By a movement on horizontal and vertical axes, the mobile unit is positioned above the pallet 1 (see FIG. 17 and arrows F10 and F11). The vertical downstroke allows the above-mentioned vertical portions 34a and 34b to move to the four flaps 8, 9, 8′, 9′ with the mobile and fixed arms 37 and 38 on opposite sides of the flaps 8, 9, 8′, 9′.

The mobile arms 37 approach the fixed arms 38 (see arrow F12 in FIG. 17), allowing the individual flaps 8, 9, 8′, 9′ to be gripped and raised away from the surfaces of the pallet 1 (see arrow F13 in FIG. 18).

The sheet formed by the film 3 cut, raised as illustrated in FIG. 18, is raised further relative to the pallet 1 thanks to the movement of the mobile unit 11 along the vertical axis (see arrow F14 in FIG. 18), and is moved away from the operating zone along the horizontal axis (see arrow F1S in FIG. 18), then set down in an unloading and storage zone (not illustrated).

An apparatus structured in this way fulfils the preset aims with significant advantages.

The film cutting and pick up operations on the surfaces 1a and 1b are extremely precise and, thanks to the special structure of the transporting assemblies, avoid tension on the products on the pallet.

Each operation is fast and does not affect the condition of the pallet, but allows high productivity without manual intervention by operators directly on the pallet to complete film removal.

The presence of the lower tear-off units prevents greater tensions on the pallet if the lower, aseptic sheet adheres to the wrapping film. This allows more delicate lifting of all of the film by the upper mobile unit.

The invention described can be subject to modifications and variations without thereby departing from the scope of the inventive concept. Moreover, all the details of the invention may be substituted by technically equivalent elements.

1. An apparatus for removing plastic film in particular stretch plastic film, from pallets (1) of products, characterised in that it comprises:
a pair of cutting devices (2), on opposite sides of the pallet (1), operating on opposite vertical surfaces (1a, 1b) of the pallet (1) and mobile at least along a horizontal axis (X), allowing the film (3) to be cut along the vertical surface (1a, 1b) and close to the upper surface (1c) of the pallet (1);
an operating unit (4) at each vertical surface (1a, 1b) cut and comprising means (5) which pick up the lower flap (6) of the film (3) cut; means (7) for cutting the film (3) along vertical axes (Z, Z′) to the base of the pallet (1), forming two separate flaps (8, 9, 8′, 9′) for each of the vertical surfaces (1a, 1b), and drive means (10) for rotating the pick up means (5), allowing the opening of each pair of flaps (8, 9, 8′, 9′) away from the vertical surface (1a, 1b);
a mobile unit (11) which picks up the pairs of flaps (8, 9, 8′, 9′) and completely removes the wrapping film (3) from the pallet (1), when the pick up means (5) release the flaps (8, 9, 8′, 9′) of film cut.

2. The apparatus according to claim 1, in which the pallet (1) has an additional lower sealing sheet (12) on the base (13) of the pallet (1), projecting from the outer perimeter of the base (13) and in stable contact with the portion of film (3) wrapped around the base (13), characterised in that it comprises means (14) for separating the additional sheet (12) of film from the wrapping film (3) at least at the further vertical surfaces (1d, 1e), still intact, of the film on the pallet (1), the separation means operating at the base (13) of the pallet (1).

3. The apparatus according to claim 2, characterised in that the separation means (14) are below a pallet (1) support and handling surface (15) and comprise two separate units (14a, 14b) positioned on opposite sides of the pallet (1) transversally to a line (L) of pallet (1) movement.

4. The apparatus according to claim 1, characterised in that the mobile pick up unit (11) comprises vertical drive means (16), which move the mobile unit (11) above the pallet (1), allowing the flaps (8, 9, 8′, 9′) of film to be picked up, and means (17) for opening the flaps (8, 9, 8′, 9′) away from the pallet (1), allowing the all of the wrapping film (3) to be picked up and removed.

5. The apparatus according to claim 1, characterised in that each cutting device (2) comprises a first transporting assembly (18) which is vertically mobile in both directions along a first vertical column (19) which is part of a frame (20) that supports the apparatus (100); each first transporting assembly (18) consisting of a support beam (21) for a cutting device (2), the latter consisting of a blade (2), and means (22) for rotating the beam (21) about the first column (19) so as to angle the blade (2) along a straight, horizontal plane for cutting the film (3) close to the upper surface (11) of the pallet (1).

6. The apparatus according to claim 5, characterised in that each first transporting assembly (18) comprises a plurality of vacuum pick up means (23) for the lower flap (6) cut, positioned on opposite sides of the blade (2) and mobile, thanks to relative means (24), between a first, back non-operating position, distanced from the surface (1a, 1b), and a second, forward position, adhering to the flap (6) close to the horizontal cut previously made, and a third, back operating position, in which the lower flap (6) is distanced from the vertical surface (1a, 1b), forming a loop in the film (3) cut.

7. The apparatus according to claims 5 and 6, characterised in that each first transporting assembly (18) comprises a pair of retaining pins (25) for the flap of film (3) distanced, positioned close to the vacuum pick up means (23) and mobile between a raised non-operating position, in which the pins (25) are distanced from the flap, and a lowered holding position, in which the pins (25) are inserted between the vertical surface (1a, 1b) and the film (3), allowing insertion of the operating unit (4).

8. The apparatus according to claim 5, characterised in that the blade (2) has a pair of support levers (26), linked to one another, connected to the support beam (21) and designed to allow an adjustment movement towards and away from the vertical surfaces (1a, 1b) of the pallet (1), allowing the blade (2) to make a stable cutting contact, in the horizontal direction, with the film (3) over the entire cutting path.

9. The apparatus according to claim 1, characterised in that the operating unit (4) comprises a pair of second transporting assemblies (27) for each vertical surface (1a, 1b) to be cut, being independent of one another and attached to a second vertical column (28, 29) which is part of a frame (20) that supports the apparatus (100); each second transporting assembly (27) having drive means (10) designed to allow synchronised movement of the second transporting assemblies (27) along the second vertical column (28, 29), allowing the pick up and cutting of the film (3) and rotation of the pairs of flaps (8, 9, 8′, 9′) thus defined at the lower end of the pallet (1).

10. The apparatus according to claim 9, characterised in that each second transporting assembly (27) comprises means (30) for the support and adjustment, about the second vertical column (28, 29), of a pair of opposite belts (5a, 5b), forming pick up means (5) for picking up and tensioning the lower flap (6) of the film (3) cut and for defining a vertical passage through which the film (3) can pass, the latter being intercepted by at least one cutter blade (7) for the film (3), supported by the second transporting assembly (27), and positioned across the vertical passage.

11. The apparatus according to claim 10, characterised in that the support and rotational adjustment means (30) for each of the second transporting assemblies (27) comprise a plurality of support arms (31), linked to one another and controlled by drive means (32) located at a carriage (33) which supports the second transporting assembly (27) and which is slidably connected to the second column (28, 29), allowing the second transporting assembly (27) to rotate between at least two end positions along a horizontal plane, one being a non-operating position, in which the second transporting assembly (27) is distanced from the vertical surface (1a, 1b) of the pallet (1), and an operating position, in which each second transporting assembly (27) is brought towards the vertical surface (1a, 1b) and close, with the pair of belts (5a, 5b), to the lower flap (6) cut.

12. The apparatus according to claims 10 and 11, characterised in that at least one of the belts (5a) in each pair of belts (5a, 5b) of each second transporting assembly (27) has a tapered end designed to allow its insertion between the lower flap (6) of film (3) cut and the vertical surface (1a, 1b) of the pallet (1).

13. The apparatus according to claims 1 and 4, characterised in that the mobile pick up unit (11) for the pair of flaps (8, 9, 8′, 9′) of film (3) comprises a frame (34) which is mobile along a bridge structure (35) above the zone for removal of the film (3) from the pallet (1); the mobile frame (34) having means (16) designed to allow a frame (34) adjustment movement in both directions along a horizontal beam (36) of the bridge structure (35) and its height adjustment, allowing the frame (34) to be moved towards and away from the pallet (1).

14. The apparatus according to claims 1, 4 and 13 characterised in that the mobile frame (34) comprises a fixed horizontal portion, on either side of which there is a rotatable vertical frame (34a, 34b), each comprising a first pair of mobile arms (37) which can be placed opposite a matching second pair of fixed arms (38), forming separate pairs of grippers for holding the rotated flaps (8, 9, 8′, 9′) of film (3); the vertical frames (34a, 34b) having drive means (39) designed so that, when the frame (34) is in the lowered position above the pallet (1), the flaps (8, 9, 8′, 9′) are picked up, raised and the flaps (8, 9, 8′, 9′) are moved away from the pallet (1) by means of simultaneous rotation of the vertical frames (34a, 34b).

15. The apparatus according to claims 2 and 3, characterised in that each tear-off unit (14a, 14b) forming the separation means (14) comprise a tear-off pin (40) which can rotate about a horizontal axis (40x), between a non-operating position, in which the pin (40) is lowered in a horizontal position, and an operating tear-off position, in which the pin (40) is raised in a vertical configuration, and at the base (13) of the pallet (1), being inserted between the film (3) and the additional lower sealing sheet (12) on the intact vertical surfaces (1d, 1e) of the pallet (1).

16. The apparatus according to claim 15, characterised in that each unit (14a, 14b) comprises an undulating guide (41), on which the pin (40) slides, the guide being designed to allow the pin (40), when moving parallel with the base (13) of the pallet (1) and in the operating tear-off position, to perform an undulating movement, tearing off the lower zone of the film (3) and the additional sealing sheet (12), on the surfaces (1d, 1e) of the pallet (1).

17. A method for removing plastic film used to wrap pallets (1) of products, in particular stretch plastic film, characterised in that it comprises the following steps:
horizontally cutting the film (3) at least at the two opposite vertical surfaces (1a, 1b) of the pallet (1) and close to the upper surface (1c) of the pallet (1);
picking up the lower flap (6) of film (3) cut and simultaneously cutting the film (3) along vertical axes (Z, Z′) to the base (13) of the pallet (1), forming two separate flaps (8, 9, 8′, 9′) for each of the vertical surfaces (1a, 1b);
opening each pair of cut flaps (8, 9, 8′, 9′) away from the vertical surface (1a, 1b), forming an “X” with said flaps (8, 9, 8′, 9′);
picking up the pairs of flaps (8, 9, 8′, 9′) and completely removing the wrapping film (3) from the pallet (1).

18. The method according to claim 17, characterised in that it comprises, prior to the pick up step, a step of tearing off the film (3) at least at the base (13) of the pallet (1) on the sides (id, le) which are still intact.
